(19) United States
(12) Patent Application Publication
(10) Pub. No.: US 2006/0039697 A1
(43) Pub. Date: Feb. 23, 2006

(54) Autonomous optical path management device

(75) Inventor: Matthew Eugene Landt, Round Rock, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/922,246

(22) Filed: Aug. 19, 2004

(51) Int. Cl. H04B 10/08

(52) U.S. Cl. 398/19

(57) ABSTRACT

An autonomous optical path management device that allows for failover without human intervention, and externally to the computer systems communicating with one another. In a preferred embodiment, a device is placed in the network between, for example, a server and a storage unit on an optical network. The device preferably contains a plurality of GBICs (though any optical-electrical interface can be used) and logic to control connections between them, as well as a power supply and some type of interface. In the event of a path failure, the logic determines which of the GBICs has a connection to other optical devices (i.e., which of the GBICs is attached to a complete optical path) and routes the electronic logic to the good GBIC. In preferred embodiments, half the GBICs are inbound, half are outbound. The logic preferably connects one of the inbound GBICs to one of the outbound GBICs, providing a single optical connection.

### CROSS REFERENCE TO RELATED APPLICATIONS

The present invention is related to the following application entitled: “Method and System for Automated Simulation of Cable Failure in a Network”, Ser. No. 10/439,038, attorney docket no. AUS920030022US1; filed on May 15, 2003, assigned to the same assignee, and incorporated herein by reference.

### BACKGROUND OF THE INVENTION

1. Technical Field

The present invention relates generally to optical communications, and particularly to management of optical paths between systems.

2. Description of Related Art

Manipulation of optical signals in an information transmission system can be accomplished using GBICs (gigabit interface converters), which are transceivers that convert serial electric signals to serial optical signals and vice versa. In networking, a GBIC is used to interface some fiber optic systems with its electrical counterparts. These fiber optic systems include Fibre Channel and Gigabit Ethernet. GBICs also are hot-swappable, which adds to the ability to upgrade an electro-optical network.

In order to provide optical path failover in fibre channel environments, redundancy in hardware is needed. In a typical system with path failover, a sending entity (such as a server or host) needs multiple adapters attached to multiple physical channels, such as multiple optical cables. This also requires multiple switches and special software specifically designed to monitor, detect, and manage the paths of the communication. For example, there are prior art systems that allow for path management from the server side, using multipath software and added hardware. Other path management systems are manually used or require special software to do automated failover.

Therefore, there is a need in the art for an autonomous optical path failover system that is cheap and easy to integrate, requires no extra software, is independent of other hardware and software (server type, subsystem type, operating system type, etc), and which provides failover even in systems that have only one adapter at a receiving end and only one port at a receiving end.

### SUMMARY OF THE INVENTION

The present invention teaches an autonomous optical path management device that allows for failover without human intervention, and externally to the computer systems communicating with one another. In a preferred embodiment, a device is placed in the network between, for example, a server and a storage unit on an optical network. The device preferably contains a plurality of GBICs (though any optical-electrical interface can be used) and logic to control connections between them, as well as a power supply and some type of interface. In the event of a path failure, the logic determines which of the GBICs has a connection to other optical devices (i.e., which of the GBICs is attached to a complete optical path) and routes the electronic logic to the good GBIC. In preferred embodiments, halt the GBICs are inbound, half are outbound. The logic preferably connects one of the inbound GBICs to one of the outbound GBICs, providing a single optical connection.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a simple optical network on which a preferred embodiment of the present invention can be implemented;

FIG. 2 shows a sample optical network with potential failure points;

FIG. 3 shows an optical network consistent with a preferred embodiment of the present inventions;

FIG. 4 shows an innovative autonomous switching device consistent with a preferred embodiment of the present invention; and

FIG. 5 shows a flowchart with process steps for implementing a preferred embodiment of the present invention.

### DETAILED DESCRIPTION OF THE PREFERRED EMBODIMENT

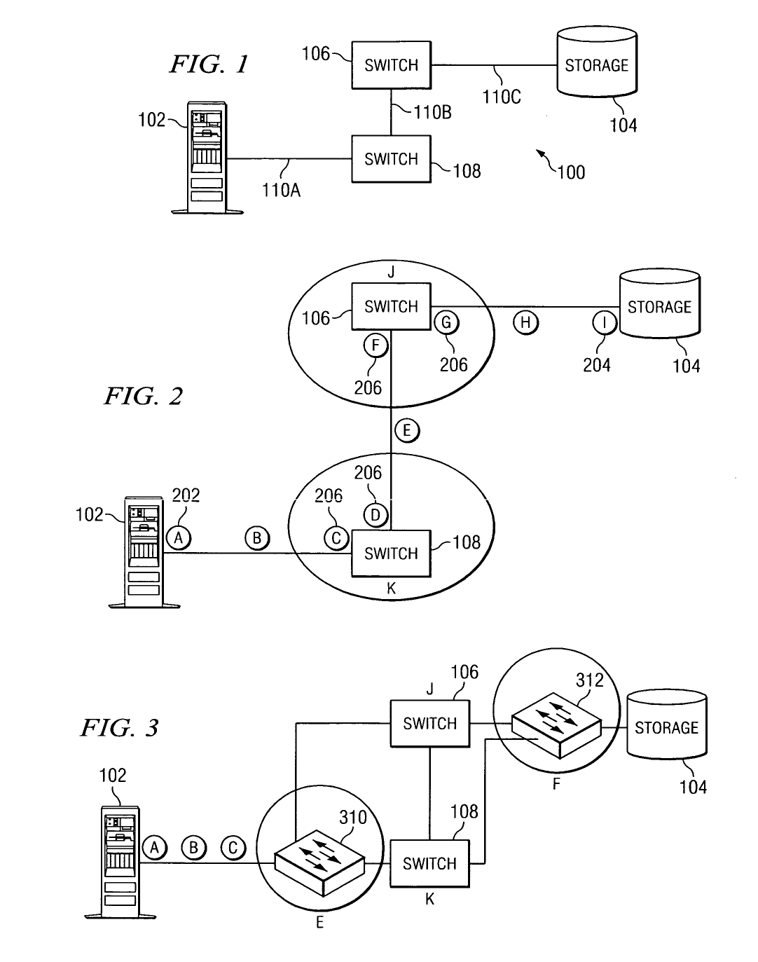

FIG. 1 depicts a simplified view of a SAN (Storage Area Network) 100, comprising server 102, storage 104 located remotely, switches 106, 108 and optical medium or cables 110A-C. Though the present invention is described with reference to a SAN, other types of network are capable of implementing the innovations of the present invention. Note that FIG. 1 depicts only a single connection in a SAN, which typically is a complex network of connections and devices.

FIG. 2 shows SAN 100 depicting more details of the system, including potential points of failure. Each lettered element A-I is a potential failure point. In this example, A is the server adapter 202, B, E, and H are cables or transmission lines, C, D, F, and G are switch GBICs 206, J and K refer to switches 106, 10, and I is storage optical connection 204.

Server 102 includes adapter 202 that connects to switch GBICs 206 of switch 108. Switch 106 also includes another GBIC 206 and connects to storage 104 optical connection or port 204. In typical systems, if path failover is to be implemented, then multiple paths, adapters, and ports are required. Without such redundancy, any failure of elements A-I results in a failed communication in the system.

FIG. 3 shows an implementation of the present invention. Server 102 is again connected to storage 104 via an optical network. In this example, innovative devices 310, 312 that include items such as GBICs for routing signals are placed in the system. Device 310 is placed between server 102 and switches 106, 108, and device 312 is placed between storage 104 and switchs 106, 108. It is noted that device 310 has connections to both switches, as does device 312. It is also noted that the example configuration allows path failover in situations where server 102 has only one adapter, and where storage 104 has only one port. Hence, failover can be achieved without altering server 102 or storage 104.

In this situation, only one complete path is ever actively connected at any one time. For example, the path could be from server 102 to device 310 to switch 106 (thus precluding an active path between device 310 and switch 108 at that time), and from switch 106 to device 312 to storage 104. If a failure occurs in the path between device 310 and switch 106, then the alternate path (the path not experiencing failure, i.e., from device 310 to switch 108) is autonomously selected by logic inside device 310. The logic detects a failed path, or that device 310 is no longer connected to an optical or electrical device, for example. Other methods of detecting a failed path can also be implemented. The switching from failed path to the alternate path preferably occurs without human intervention or the need for complex software present on server 102 or storage 104. Likewise, device 312 controls connections to the paths between device 312 and either switch 106, 108.

In other embodiments, there can be added sections of cable to increase redundancy. For example, if device 312 includes two inbound GBICs (i.e., GBICs adapted to receive inbound messages from server 102) with cable connecting both GBICs to server 102, then if one of these links between device 312 and server 102 fails, device 312 can switch to the still valid link. Such implementations may require more adapters, for example, at server 102.

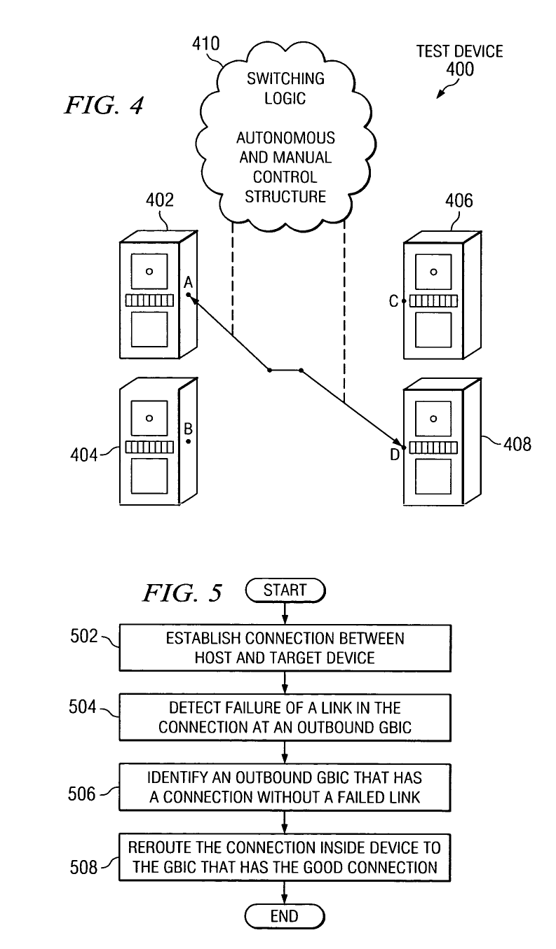

FIG. 4 shows an example of innovative device 312 in more detail. In this example, device 400 includes optical-electrical devices 402, 404, 406, 408 such as a GBICs. Device 400 also includes switching logic for autonomous and/or manual control 410. In this example, GBIC 402 is connected to GBIC 408. In preferred embodiments, logic 410 is capable of switching the connections between the inbound GBICs 402, 404 and outbound GBICs 406, 408.

For example, in one implementation GBIC 106 has an optical connection to switch 106, while GBIC 408 has an optical connection to switch 108. Only one of these links is active at any given time. If the link to switch 106 is active, and later experiences failure, then logic 410 detects the failure, then checks whether GBIC 408 has a valid connection (to switch 108 in this case). If GBIC 408 has a valid connection, then logic 410 autonomously switches device 400 to connect GBIC 402 to GBIC 408, providing failover. Alternatively, logic 410 can constantly monitor all connections from GBICs to alleviate the need to detect an active optical connection after failure of one path. In other words, the present invention can be implemented with different types of logic, for example, to constantly monitor connections or to only seek active connections when a failure is detected, or other types of logic to implement failover. The specific order or arrangement of the logic is not intended to limit the innovations of the present invention.

FIG. 5 shows process steps for implementing a preferred embodiment of the present invention. In this example, an optical system such as that shown in FIG. 3 establishes a connection between a first device (such as server 102) and a target device (such as storage 104) (step 502). Logic 410 of device 400 (such as device 310) detects a failure of a link in the connection, for example, at outbound GBIC 408 (step 504). Logic 410 identifies an outbound GBIC (e.g., GBIC 406) that has a connection without a failed link (step 506) and autonomously reroutes the connection inside device 400 to the GBIC that has the valid connection (step 408).

Hence, it one of the currently used GBICs loses connection to the optical network, the logic will see the optical path failure and automatically reroute to a different “connected” GBIC, if one is available. Note that the GBICs are not necessary to the design, and can be replaced by any type of optical-electrical converter.

The innovations of the present invention can be used in other situations than those described above. For example, the present innovations can be used to manage connections in a way that allows for reconfiguration of or addition to the network without interrupting service. For example, a system monitoring device such as a finisar could be manually added without loss of service. For example, such a device could be added on an invalid (not in use) link of the network while the computer systems communicate over a valid link. When the monitoring device is in place, the innovative device with GBICs could reroute its connections away from the previous links and redirect traffic to the links with the newly added equipment. This would cause no more loss or downtime than it takes for the switch to be thrown or activated. Other implementations and uses will be evident to those of skill in the art.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A system for managing an optical path, comprising:
a first computer system attached to an optical network;
a second computer system attached to the optical network;
at least one device connected between the first computer system and the second computer system on the optical network, wherein the device autonomously detects a failed link in the network and autonomously reroutes communication to a valid link in the network.

2. The system of claim 1, wherein the device includes a first inbound optical-electrical device connected to receive data from the first computer system, and first and second outbound optical-electrical devices connected to send the data to the second computer system, the first and second outbound optical-electrical devices each connected to the second computer system through a different path.

3. The system of claim 2, wherein the device reroutes communication to a valid link in the network by switching a connection between the first inbound optical-electrical device and the first outbound optical-electrical device to a connection between the first inbound optical-electrical device and the second outbound optical-electrical device.

4. The system of claim 2, wherein the optical-electrical device is a gigabit interface converter (GBIC).

5. The system of claim 1, wherein only one adapter of the first computer system has access to the network.

6. The system of claim 1, wherein the first computer system and the second computer system each only have one connection to the network.

7. A device for use in an optical network, comprising:
at least one input optical-electrical device connected to receive input from a first computer system;
at least two output optical-electrical devices, each being connected to an optical network;
logic capable of connecting the at least one input optical-electrical device to either of the at least two output optical-electrical devices.

8. The device of claim 7, wherein the logic autonomously switches the connection of the at least one input optical-electrical device from a first output optical-electrical device to a second output optical-electrical device.

9. The device of claim 7, wherein the optical-electrical devices are gigabit interface converters (GBICs).

10. The device of claim 7, wherein only one adapter of the first computer system has access to the network.

11. The device of claim 7, wherein when a first path across the optical network from the first computer system to the second computer system fails, the device autonomously switches to a second path from the first computer system to the second computer system.

12. A method of providing path failover an optical network, comprising the steps of:
establishing a connection between a first computer system and a second computer system across an optical network, the optical network having at least one device attached thereto, the device including a plurality of optical-electrical devices;
when a first path of the optical network fails, switching from the first path to a second path of the optical network;
wherein the step of switching is accomplished autonomously by the device.

13. The method of claim 12, wherein the plurality of optical-electrical devices are gigabit interface converters (GBICs).

14. The method of claim 12, wherein the first computer system and second computer system each only have one connection to the optical network.

15. The method of claim 12, wherein the device includes a first inbound optical-electrical device connected to receive data from the first computer system, and first and second outbound optical-electrical devices connected to send the data to the second computer system, the first and second outbound optical-electrical devices each connected to the second computer system through a different path.

16. The method of claim 15, wherein the device reroutes communication to a valid link in the network by switching a connection between the first inbound optical-electrical device and the first outbound optical-electrical device to a connection between the first inbound optical-electrical device and the second outbound optical-electrical device.

17. A computer program product in a computer readable medium for providing path failover an optical network, comprising:
first instructions for establishing a connection between a first computer system and a second computer system across an optical network, the optical network having at least one device attached thereto, the device including a plurality of optical-electrical devices;
when a first path of the optical network fails, second instructions for switching from the first path to a second path of the optical network;
wherein the step of switching is accomplished autonomously by the device; and
wherein the second instructions comprise logic of the device.

18. The computer program product of claim 17, wherein the plurality of optical-electrical devices are gigabit interface converters (GBICs).

19. The computer program product of claim 17, wherein the first computer system and second computer system each only have one connection to the optical network.

20. The computer program product of claim 17, wherein the device includes a first inbound optical-electrical device connected to receive data from the first computer system, and first and second outbound optical-electrical devices connected to send the data to the second computer system, the first and second outbound optical-electrical devices each connected to the second computer system through a different path.

21. The computer program product of claim 20, wherein the device reroutes communication to a valid link in the network by switching a connection between the first inbound optical-electrical device and the first outbound optical-electrical device to a connection between the first inbound optical-electrical device and the second outbound optical-electrical device.
